(19) United States
(12) Patent Application Publication
(10) Pub. No.: US 2015/0144239 A1
(43) Pub. Date: May 28, 2015

(54) WHEEL OR TYRE

(71) Applicant: Roger Frederick Hiscock, Worcester (GB)

(72) Inventor: Roger Frederick Hiscock, Worcester (GB)

(21) Appl. No.: 14/397,294

(22) PCT Filed: Mar. 15, 2013
(86) PCT No.: PCT/GB2013/050656

§ 371 Date: Oct. 27, 2014

(30) Foreign Application Priority Data
Apr. 27, 2012 (GB) 1207332.6

(51) Int. Cl. B60C 11/03

(52) U.S. Cl. CPC B60C 11/03
USPC 152/209.1; 29/428

(57) ABSTRACT

A wheel or tyre for a bicycle comprises a ground-contacting surface, at least a portion of the ground-contacting surface being carried on a movable portion having a degree of freedom about an axis parallel to a circumference of the wheel or tyre. The wheel or tyre may enable a rider of a bicycle, when cornering, to perform or simulate a drift, slide, broadside or skid.

### CROSS REFERENCE TO RELATED APPLICATIONS

This is the U.S. National Phase Application under 35 U.S.C. §371 of International Patent Application No. PCT/GB2013/050656 filed Mar. 15, 2013, which claims the benefit of British Patent Application No. 1207332.6 filed on Apr. 27, 2012, both of which are incorporated by reference herein.

### FIELD OF THE INVENTION

The present invention relates to a wheel or tyre for a bicycle or the like. More particularly, the invention relates to a wheel or tyre for a bicycle that may allow a rider of the bicycle to perform or simulate a drift, slide, broadside or skid.

### BACKGROUND

Typically, a rider of a bicycle may be able to perform a drift, slide, broadside or skid when cornering on a loosely packed surface, e.g. dirt, gravel or shale.

On a standard road surface, e.g. tarmac or asphalt, it may be much more difficult for a rider to do this whilst remaining in control of the bicycle, i.e. without crashing and/or falling off the bicycle.

### SUMMARY

It is a non-exclusive object of the invention to provide a means to allow a rider of a bicycle to be able to perform or simulate a manoeuvre or trick such as a drift, slide, broadside or skid in a controllable manner on standard road surfaces as well as loosely-packed “off-road” surfaces.

A first aspect of the invention provides a wheel or tyre for a bicycle comprising a ground-contacting surface, at least a portion of the ground-contacting surface being carried on a movable portion having a degree of freedom about an axis parallel to a circumference of the wheel or tyre.

The wheel or tyre may enable a rider of a bicycle, when cornering, to perform or simulate a drift, slide, broadside or skid.

The degree of freedom may comprise an elliptical or circular path or a part thereof, e.g. an arc. The degree of freedom may comprise a helical or spiral path or a part thereof.

In a preferred embodiment, the wheel or tyre may be configured such that the movable portion can move, in use, by no more than a predetermined amount. The predetermined amount may be measured relative to a plane of rotation of the wheel or the tyre, in use, i.e. when the wheel or tyre is fitted to a bicycle.

Alternatively, there may be no built-in restriction on the amount the movable portion can move, in use. For instance, the movable portion may be freely rotatable about the axis parallel to the circumference of the wheel or tyre. The movable portion may comprise a roller having a continuous outer surface, e.g. a cylindrical roller, a barrel-shaped roller, a ball-shaped, e.g. substantially spherical, roller or an ovoid-shaped roller.

Typically, the predetermined amount may be significantly less than a full rotation about the axis parallel to the circumference of the wheel or tyre. Preferably, the predetermined amount may be no more than 90° or no more than 70° or no more than 60° in each direction from a central point, e.g. relative to the plane of rotation of the wheel or tyre, in use. The predetermined amount may preferably constitute an arc of no more than 180°. The predetermined amount may not be the same in each direction from the central point. Thus, the wheel or tyre may be configured such that a rider may be able to perform, in use, a drift, slide, broadside or skid to a greater or lesser extent when cornering in one sense (to the left or to the right) than when cornering in the other sense.

Preferably, the ground-contacting surface may be curved.

The movable portion may comprise a roller segment. Preferably, in cross-section the roller segment may comprise a sector having a central angle of no more than 180°. The roller segment may be a segment of a cylindrical roller, a barrel-shaped roller, a ball-shaped, e.g. substantially spherical, roller, or an ovoid-shaped roller.

Preferably, the or each roller or roller segment may have a radius of no more 50 mm. The or each roller or roller segment may have a radius of 5 mm or more. For instance, the or each roller or roller segment may have a radius of 25 mm or 10 mm.

The roller segments or rollers may be solid or hollow. Typically, it may be desirable to reduce or minimise the density of the roller segments or rollers, since this may reduce or minimise the overall weight of the tyre and/or the volume and cost of the materials used in manufacture of the wheel or tyre. For instance, the roller segments or rollers may have a lower density portion, e.g. a lower density core. For instance, such a lower density portion may be made from a polymeric material, e.g. Nylon®. Additionally or alternatively, the roller segments may be made at least in part from a foam, a reticulated or a honeycomb-structured material.

Preferably, the wheel or tyre may comprise at least one stop means arranged to prevent the movable portion moving beyond the or a predetermined amount.

Preferably, the wheel or tyre may comprise at least one resilient element connecting the or each movable portion to a fixed point on the wheel or the tyre. The movable portion may be resiliently tiltable or rotatable.

In a preferred embodiment, the wheel or tyre may comprise: at least one resilient element connecting the or each movable portion to a fixed point on the wheel or the tyre and at least one stop means; wherein the resilient element(s) and the stop means are arranged such that, in use, the movable portion is resiliently tiltable or rotatable by no more than the or a predetermined amount relative to the or a plane of rotation of the wheel or the tyre.

The movable portion may comprise a flexible neck portion and a head portion carrying the ground-contacting surface.

The movable portion may comprise a stud, a fin or a rib.

Preferably, the wheel or tyre may comprise a plurality of movable portions, which may be spaced around the circumference of the wheel or tyre. The plurality of movable portions may be regularly spaced around the circumference of the wheel or tyre.

Preferably, the ground-contacting surface may comprise a tread.

Preferably, the wheel or tyre may comprise a locking means which may be engagable to prevent or at least minimise movement of the movable portion.

Optionally, the wheel or tyre may be provided as a kit of component parts that may be assembled and configured by the user.

In an embodiment, the wheel or tyre may comprise a plurality of separable tyre elements or rollers, which, when assembled, comprise at least part of a tyre.

The wheel or tyre may further comprise a plurality of separate spacers, separating each adjacent pair of tyre elements.

In an embodiment of a wheel or tyre comprising a plurality of rollers, the wheel or tyre may further comprise a plurality of separate roller housings, each roller housing supporting a roller bearing.

In an embodiment of a wheel or tyre comprising a plurality of tyre elements, each tyre element may comprise:

a base portion configured to be at least partially received within a wheel rim;

a head portion comprising a ground contacting surface; and

a resiliently deformable neck portion joining the head portion to the base portion.

In an embodiment, the wheel or tyre may further comprise an elongate, flexible member for securing the plurality of tyre elements or rollers to the wheel rim, each tyre element or roller having a through hole for accepting the elongate member.

In an embodiment, the elongate member may comprise a threaded portion at an end thereof.

The elongate member may comprise a threaded portion at a first and second end thereof. Typically, the threaded portion at the first end may be left-hand threaded, and the threaded portion at the second end may be right-hand threaded.

The wheel or tyre may further comprise a nut, the nut comprising a first threaded portion and a second threaded portion, the first and second threaded portions of the nut respectively corresponding to the threaded portion at the first and second end of the elongate member.

In an embodiment, the stop means may comprise a wheel rim.

In an embodiment, the moveable portions may be fixed to a base, the base being configured to be received at least partially within a wheel rim. The base may have a first and second end, wherein the first and second end of the base are adapted to be secured together by removable fastening means.

The removable fastening means may be operable to tension the wheel around the wheel rim.

Any component or parts of the wheel or tyre that may be made from rubber may be made from virgin rubber, recycled rubber or mixtures or blends thereof.

A second aspect of the invention provides a bicycle comprising at least one wheel or tyre according to the first aspect of the invention. Preferably, a rear wheel of the bicycle may be fitted with the wheel or tyre according to the first aspect of the invention. A front wheel of the bicycle may comprise a standard wheel or tyre.

Advantageously, the invention may enable a rider of the bicycle, when cornering, to perform or simulate a drift, slide, broadside or skid.

A third aspect of the invention provides a method of manufacture or assembly of a bicycle comprising: providing a wheel according to the first aspect of the invention and a bicycle frame; and fitting the wheel according to the first aspect of the invention to the bicycle frame.

A fourth aspect of the invention provides a method of manufacture or assembly of a bicycle comprising: providing a tyre according to the first aspect of the invention, a bicycle frame and a bicycle wheel for fitting to the bicycle frame; fitting the tyre according to the first aspect of the invention to the wheel; and subsequently fitting the wheel to the bicycle frame.

A fifth aspect of the invention provides a method of modifying a bicycle comprising replacing a wheel or tyre of the bicycle with a wheel or tyre according to the first aspect of the invention.

In this application, the term “tyre” should be understood to refer to any band, ring or hoop that is attached to a rim of a wheel. Typically, the tyre may provide traction and/or reduce road shocks. The tyre may be made primarily from rubber. The tyre may or may not be a pneumatic, i.e. air-filled, tyre.

### BRIEF DESCRIPTION OF THE DRAWINGS

In order that the invention may be well understood it will now be described, by way of example only, with reference to the accompanying drawings, in which:

FIG. 1 shows a portion of a first embodiment of a tyre according to the invention;

FIG. 2 shows a portion of a part-assembled second embodiment of a tyre according to the invention;

FIG. 3 shows a cross-section of a fully-assembled second embodiment of a tyre according to the invention;

FIG. 4 shows a cross-section of a fully-assembled second embodiment of a tyre according to the invention;

FIG. 5 shows a portion of a part-assembled embodiment of a wheel according to the invention;

FIG. 6 shows a cross-section of a fully-assembled embodiment of a wheel according to the invention;

FIG. 7 shows a portion of part-assembled third embodiment of a tyre according to the invention;

FIG. 8 shows a cross-section of a fully-assembled third embodiment of a tyre according to the invention;

FIG. 9 shows a cross-section of a joining section within the third embodiment of a tyre according to the invention;

FIG. 10 shows a further detail of the joining section shown in FIG. 10;

FIG. 11a shows a fastening means for use with an assembled fourth embodiment of a tyre according to the invention;

FIG. 11b shows a cross-section of the assembled fourth embodiment of a tyre according to the invention;

FIG. 12 shows a side view of the assembled fourth embodiment;

FIG. 13 shows a side view of an assembled fifth embodiment of a tyre according to the invention,

FIG. 14a shows an end view of a spacer element of the fifth embodiment;

FIG. 14b shows a side view of the spacer element of the fifth embodiment;

FIG. 15a shows an end view of a tyre element of the fifth embodiment;

FIG. 15b shows a side view of the tyre element of the fifth embodiment;

FIG. 16a shows an end view of a nut of the fifth embodiment;

FIG. 16b shows a side view of the nut of the fifth embodiment;

FIG. 17 shows a side view of a hoop of the fifth embodiment;

FIG. 18 shows an assembled sixth embodiment of a tyre according to the invention;

FIG. 19 shows a side view of a nut of the sixth embodiment;

FIG. 20a shows an end view of a portion of the sixth embodiment;

FIG. 20b shows a side view of a roller section of the sixth embodiment;

FIG. 21 shows a section of a seventh embodiment of a tyre according to the invention;

FIG. 22 shows a side view in partial cross-section of the seventh embodiment; and

FIG. 23 schematically shows a bicycle according to the invention.

### DETAILED DESCRIPTION

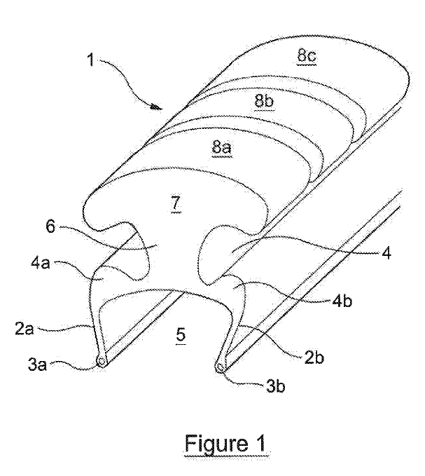

FIG. 1 shows a portion of a first embodiment of a tyre 1 according to the invention. The tyre 1 is a rubber, clincher-type tyre for fitting to a rim of a bicycle wheel. The tyre 1 comprises a continuous ring, but only a portion is shown for clarity. The tyre 1 comprises a pair of opposite side walls 2a, 2b. Each side wall 2a, 2b terminates at its lower end in a bead 3a, 3b, which extend around the circumference of the tyre 1. At their upper ends, the side walls 2a, 2b are joined by an intermediate portion 4. The intermediate portion 4 provides an upper surface for a chamber 5, defined when the tyre is fitted to a wheel (not shown) by the intermediate portion 4, the two side walls 2a, 2b and a rim (not shown) of the wheel. Typically, in use, an inner tube (not shown) may be located within the chamber 5.

The intermediate portion 4 has an upper surface from a central region of which a neck 6 extends vertically to a head portion 7. The head portion 7 is wider than the neck 6 and has a curved top surface 8a. The upper surface of the intermediate portion 4 has a hump 4a, 4b at each of its edges, which extends around the circumference of the tyre 1.

As shown in FIG. 1, the tyre comprises a plurality of discrete head portions. In FIG. 1, three head portions having upper surfaces 8a, 8b, 8c respectively are shown. It will be appreciated that regularly spaced discrete head portions are provided on neck portions around the circumference of the tyre 1. The upper surfaces of the head portions typically may be provided with a tread (not shown), which may be of any suitable design.

The side walls 2a, 2b and beads 3a, 3b may be of relatively standard design and construction. The neck portion 6 and head portion 7 are made from rubber. The tyre 1 may be formed as a single piece or the neck and head portions may be adhered or otherwise fixed to the upper surface of the intermediate portion. The rubber composition of the neck portion 6 may be different from the rubber composition of the head portion 7. Fibres and/or other reinforcing elements may be employed where required. For instance, the fibres and/or other reinforcing elements may improve or strengthen the or a join between the neck portion 6 and the intermediate portion 4. Additionally or alternatively, the fibres and/or other reinforcing elements may help the tyre to resist compression.

When fitting the tyre 1 to a wheel (not shown), the beads 3a, 3b engage with flanges in the rim of the wheel to hold the tyre in place. The tyre may then be inflated by pumping air into an inner tube (not shown) located within the chamber 5.

With the tyre 1 fitted to a bicycle, e.g. to the rear wheel of a bicycle, a rider may perform or simulate a manoeuvre or trick such as a drift, slide, broadside or skid when cornering. If, for example, upper surface 8a is in contact with the ground at the time the rider tries to do this, then the neck portion 6 will flex allowing the head portion 7 to tilt to the left or right depending on the direction in which the rider is turning the bicycle. The head portion 7 may come into contact with one of the humps 4a, 4b, which thus act to prevent the head portion from tilting beyond a certain distance. The resilient nature of the neck portion 6 may also serve to control the distance the head portion 7 can move and may help the head portion 7 to return to its central, rest position once the manoeuvre or trick is completed.

In this embodiment, further control may be provided by varying the pressure within the tyre 1. When the air pressure is high, the distance from the head portion 7 to the humps 4a, 4b is greater than when the air pressure is low. The intermediate portion 4 may collapse into the chamber 5 at lower air pressures. In particular, the tyre 1 may be configured such that at very low air pressures, the head portion 7 carrying the ground-contacting surface and humps 4a, 4b are very close or in even contact, such that the tyre does not assist the rider in performing or simulating maneuvers or tricks. By varying the air pressure, the amount by which the head portion can move in either direction may be controlled. The greater this predetermined amount, the greater the extent of the drift, slide, broadside or skid that the rider can perform or simulate. Advantageously, varying the air pressure may provide further control of the predetermined amount by no more than which the head portion can move. For instance, a rider may start off using the tyre at an air pressure that allows no more than a relatively low predetermined amount of movement before changing the pressure as his confidence increases and skills improve.

The person skilled in the art will appreciate that the compositions, size and dimensions of the parts of the tyre, e.g. the neck portion, the head portion and the upper surface of the intermediate portion may be varied widely without departing from the scope of the invention. Accordingly, the tyre may be optimised for particular types and sizes of bicycle and/or for particular types of rider and/or riding styles and/or for use on particular surface types.

For instance, the neck portion and/or the head portion may be hollow at least in part. Advantageously, this may help to reduce or minimise the overall weight of the tyre.

Additionally or alternatively, the neck portion may comprise one or more resilient elements, e.g. springs or the like, which may, for instance, be made from a metal or any other suitable material. Any such resilient elements may be configured to provide the neck portion with a desired level of resilience. A suitable resilient element may comprise a T-shaped element, e.g. made from Nylon®, at least partially embedded or encapsulated within the tyre. Alternatively or additionally, a resilient element having the form of a spine or comb extending a distance around the circumference of the tyre as well as a distance up the neck portion may be incorporated within the tyre.

The neck portion and/or the head portion may be made principally from metal or a metal alloy. A metal head portion may be coated with a layer of rubber, which may comprise a tread, in order to provide a good quality ground-contacting surface.

In an alternative embodiment, the neck portions and head portions may be affixed directly to the rim of a wheel. In such an embodiment, there may be no the chamber for accommodating an inner tube.

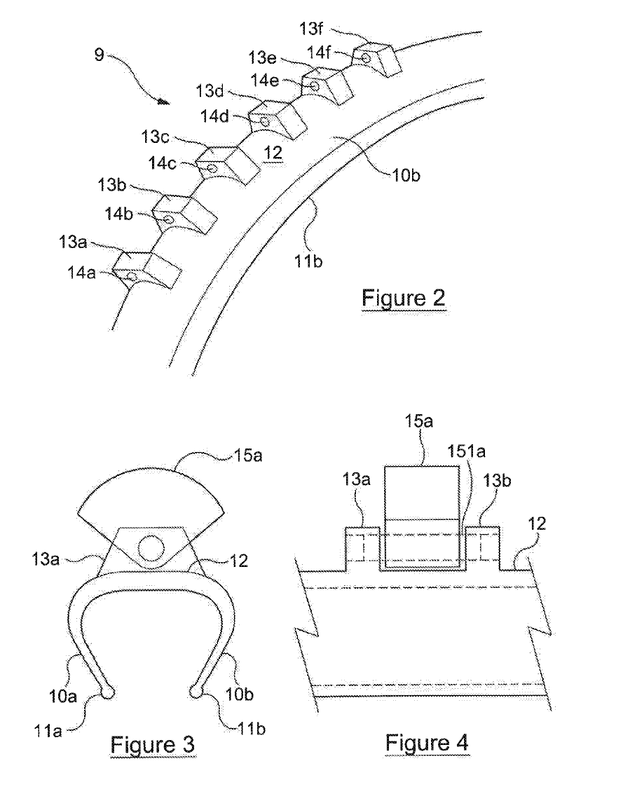

FIGS. 2, 3 and 4 show a second embodiment of a tyre according to the invention. Referring to FIG. 2, a tyre 9 is shown part assembled. The tyre 9 essentially comprises a clincher-type tyre, but only a portion of the circumference of the tyre is shown in FIG. 2 for clarity. The tyre 9 comprises a pair of opposite side walls 10a, 10b. A bead 11a, 11b is provided at the lower end of each side wall 10a, 10b respectively. Each bead 11a, 11b extends around the circumference of the tyre 9. An intermediate portion 12 connects the side wall 10a, 10b. As can best be seen in FIG. 3, the side walls 10a, 10b and the intermediate portion 12 define three sides of a chamber which would be formed when the tyre 9 is fitted to a rim of a wheel. Typically, the chamber would accommodate an inner tube.

Referring to FIG. 2, the part assembled tyre has a castellated appearance, due to a plurality of spaced apart trapezoidal protrusions, each of which protrudes radially outwards from the intermediate portion 12. Six trapezoidal protrusions 13a, 13b, 13c, 13d, 13e, 13f are shown in FIG. 2. Each trapezoidal protrusion 13a, 13b, 13c, 13d, 13e, 13f has a flat rectangular top, which is smaller than the rectangular footprint of its base in a direction across the width of the tyre, but is the same size as the rectangular footprint of its base in a direction along the circumference of the tyre. Accordingly, each trapezoidal protrusion 13a, 13b, 13c, 13d, 13e, 13f has a pair of sloping opposite side walls and a pair of substantially vertical opposite end walls. Each trapezoidal protrusion 13a, 13b, 13c, 13d, 13e, 13f has an aperture 14a, 14b, 14c, 14d, 14e, 14f therethrough. Each aperture 14a, 14b, 14c, 14d, 14e, 14f extends through a central region of its respective trapezoidal protrusion 13a, 13b, 13c, 13d, 13e, 13f in a direction along the circumference of the tyre. As can be seen in FIG. 3, a vertical line of symmetry through trapezoidal protrusion 13a would bisect aperture 14a.

In order to completely assemble the tyre 9, a roller segment, typically made from rubber, is fitted between each pair of neighbouring trapezoidal protrusions. For example, as shown in FIGS. 3 and 4, a roller segment 15a having the form of approximately a quarter of a cylinder is fitted between trapezoidal protrusion 13a and trapezoidal protrusion 13b. In cross-section the roller segment comprises a sector having a central angle of approximately 90°. The roller segment 15a is carried on and freely rotatable about a tube or rod 151a, which is typically made from metal. A first end of the tube or rod 151a is received in aperture 14a and a second end of the tube or rod 151b is received in aperture 14b, in order to fit the roller segment 15a in place.

When fitting the tyre 9 to a wheel (not shown), the beads 11a, 1 lb engage with flanges in the rim of the wheel to hold the tyre in place. The tyre 9 may then be inflated by pumping air into an inner tube (not shown) accommodated between the rim and the tyre.

With the tyre 9 fitted to a bicycle, e.g. to the rear wheel of a bicycle, a rider may perform or simulate a manoeuvre or trick such as a drift, slide, broadside or skid when cornering. If, for example, the curved surface of the roller segment 15a is in contact with the ground at the time the rider tries to do this, then the roller segment 15a will rotate about the tube or rod 151a in an anticlockwise or clockwise direction depending on the direction in which the rider is turning the bicycle. The roller segment 15a may come into contact with the intermediate surface 12, which may thus act to prevent the roller segment 15a from rotating beyond a certain distance. The roller segment 15a may or may not rotate back to its central, rest position once the manoeuvre or trick is completed.

The roller segments may be solid or hollow.

Preferably, the curved surface of each roller segment may comprise rubber or a similarly hard-wearing, tough and/or resilient material to provide traction and to absorb road shocks. The remainder of the roller segment need not be made from the same material as the curved surface. For instance, it could be made from a plastic, a metal or alloy with a rubber layer being provided as a coating on the curved surface. Optionally, the curved surface of each roller segment may be provided with a tread.

By changing the dimensions of the roller segments, e.g. so that they constitute a greater or lesser proportion of a cylinder, it may be possible to vary the extent to which maneuvers and/or tricks can be simulated or performed. A bigger segment of a cylinder may be able to rotate less far before coming into contact with the intermediate surface than would a smaller segment.

Similarly, by changing the height of the apertures, i.e. the distance between each aperture and the intermediate portion, the maximum permitted rotation may be varied. Optionally, each trapezoidal protrusion may be provided with a series of apertures at varying heights to allow the tyre to be configured in a plurality of ways, i.e. to enable bigger or smaller drifts, slides, broadsides or skids.

Nevertheless, the dimensions of the roller segments and/or the relative positions of the apertures should be selected such that the curved surface of a given roller segment is always in contact with the ground, even when the given roller segment has rotated the maximum allowed amount in either direction.

Optionally, each roller segment may have a resilient element associated with it, in order to bias it towards its central, rest position. Additionally or alternatively, locking means may be provided, which locking means when engaged may be operable to prevent the roller segments from rotating. When the locking means are disengaged, the roller segments may be free to rotate.

A cable or flexible tube passing through a plurality of trapezoidal protrusions and roller segments may be used instead of a discrete metal tube or rods for each roller segment. A single cable or flexible tube may pass around the circumference of the tyre.

In some embodiments, a retention cable may be provided, which passes around the circumference of the tyre and through the discrete metal tubes. This may provide additional safety and may make the tyre more robust.

The tyre 9 may be provided or sold fully assembled or as a kit which the user can configure to suit his or her requirements, e.g. by fitting roller segments of a particular size. Advantageously, in some embodiments, a user may be able to replace one or more roller segments with other roller segments, e.g. to replace any damaged roller segments or to replace all of the roller segments with roller segments of a different size. Typically, it will be necessary to deflate the tyre, in order to fit or replace roller segments. When the tyre is fully inflated, the tubes or rods are very securely held in place.

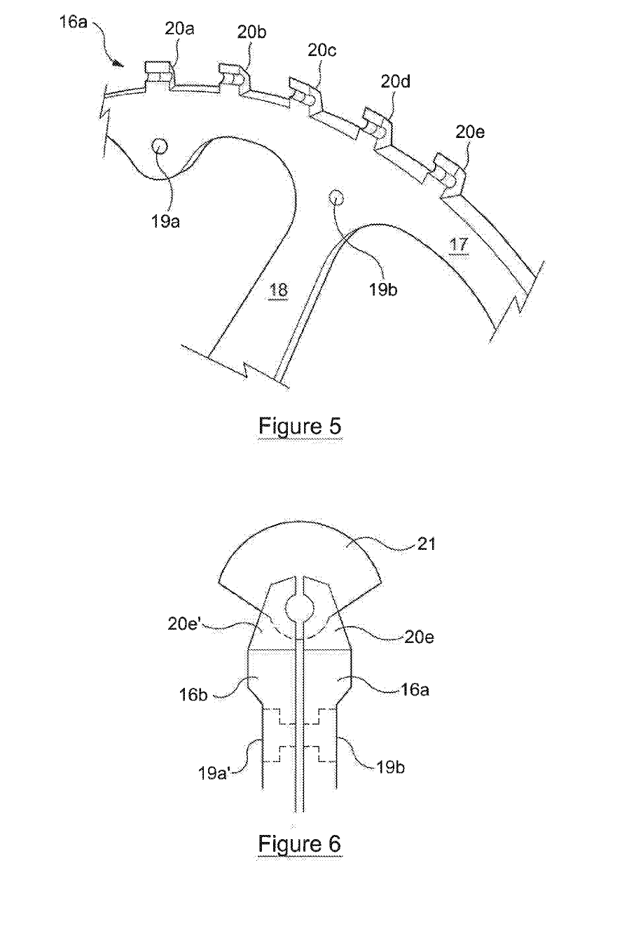

FIGS. 5 and 6 show portions of an embodiment of a wheel according to the invention. The wheel is made up of a first half-wheel 16a and a second half-wheel 16b. Conveniently, the half-wheels 16a and 16b may be formed by die casting. A portion of the first half-wheel 16a is shown in FIG. 5. The first half-wheel 16a comprises a rim portion 17 from which extending radially inwards to a hub (not shown) is a spoke 18. A first aperture 19a passing through the half-wheel 16a is provided in an inward bulge in the rim portion 17 located a distance around the rim from where the spoke 18 meets the rim 17. A second aperture 19b passing through the half-wheel 16a is provided in the vicinity of where the spoke 18 meets the rim 17. Regularly spaced around the edge of the rim 17 are five protrusions 20a, 20b, 20c, 20d, 20e, each protrusion having an open channel in a side wall, which extends through the protrusion in a direction along the circumference of the half-wheel 16a. It should be appreciated that the portion of the half-wheel 16a shown in FIG. 5 is illustrative of the complete half-wheel 16a.

As will be appreciated from FIG. 6, two half-wheels 16a and 16b are fixed together to form a wheel. The two half-wheels are basically the same. When bringing the two half-wheels together, protrusions are aligned such that the open channels define passageways. The two half-wheels are also aligned so that the aperture 19a is aligned with an aperture in a spoke of the second half-wheel 16b and the aperture 19b is aligned with an aperture in an inward bulge in a rim portion of the second half-wheel 16b. Mechanical fixing means, e.g. screws and nuts, may be passed through these apertures to fix the two half-wheels together.

Roller segments may be fitted to the wheel essentially as described above in relation to FIGS. 2, 3 and 4. The same or equivalent considerations apply and the equivalent variations are possible. FIG. 6 shows an example of a cross section of an assembled wheel. As can be seen from FIG. 6, the two half-wheels 16a, 16b have been brought together. Aperture 19b in the first half-wheel 16a is aligned with an aperture 19a′ in the second half-wheel 16b. Both apertures are countersunk so that the fixing means do not protrude from the wheel. Protrusion 20e in the first half-wheel 16a is aligned with protrusion 20e′ so as to create a passageway. A first end of tube or rod is received in this passageway. A roller segment 21 is mounted on and freely rotatable about the tube or rod.

The two half-wheels may be made by any suitable manufacturing process and from any suitable material, e.g. a metal, an alloy, carbon fibre or a composite or combinations thereof. The two half-wheels may be joined together by other means, e.g. by welding, riveting or use of an adhesive.

Alternatively, the wheel may be made as a single piece.

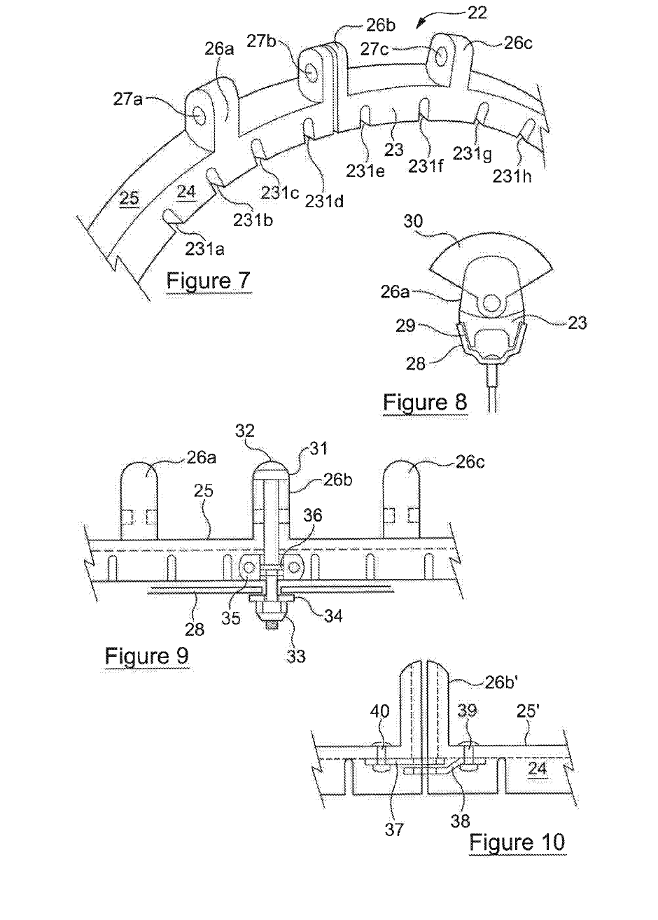

FIGS. 7, 8, 9 and 10 show a third embodiment of a tyre according to the invention.

Referring to FIG. 7, a part assembled tyre 23 comprises a Nylon® band 24 having two ends. The Nylon® band has an upper surface 25 and a pair of opposite side walls extending downwardly therefrom. A plurality of cuts 231a, 231b, 231c, 231d, 231e, 231f, 231g, 231h is provided in the side walls, in order to enable the nylon band 24 to be wrapped around the rim of the wheel 28, in use.

As shown in FIG. 7, the Nylon® band 24 has a castellated appearance, due to a plurality of spaced apart curved-topped protrusions, each of which protrudes radially outwards from the upper surface 25. Three curved-topped protrusions 26a, 26b and 26c are shown in FIG. 7. Each curved-topped protrusion has an aperture 27a, 27b, 27c respectively passing through it in a direction along the length of the band 24. The middle one of these three protrusions 26b is made up of two half-protrusions, each half-protrusions being located on an end of the band 24. When the band 24 is fitted to a wheel, this protrusion 26b is completed.

Roller segments can be fitted between pairs of neighbouring protrusions, when assembling the tyre. The roller segments may be fitted to the wheel essentially as described above in relation to FIGS. 2, 3 and 4. The same or equivalent considerations apply and the equivalent variations are possible. FIG. 8 shows a roller segment 30 fitted between curved-topped protrusion 26a and curved-topped protrusion 26b.

As shown in FIG. 8, the tyre 23 can be fitted into a rim 28 of a wheel. A rubber membrane 29 is placed between the tyre 23 and the rim 28 to provide a seal and prevent ingress of dirt. The use of rubber membrane 29 may be optional. Typically, the tyre 23 may be used without an inner tube.

In order to complete the assembly of the tyre, it is necessary to join the two ends of the band 24 together and to secure the tyre to the wheel. A preferred method of doing this is shown in FIGS. 9 and 10. A first link 35 extends from a first end of the band 24 and a second link 36 extends from a second end of the band 24. The links 35, 36 have apertures, which align with each other when the band 24 is fitted to the rim of a wheel. As shown in FIG. 9, a domed washer 31 is provided on top of curved-topped protrusion 26b. A screw 32 passes through the washer 31 and along a passageway defined in part by each half-protrusion, through the aligned apertures in the two links 35, 36, through the rim 28 (conveniently via the standard hole provided for the air valve) and through a washer 34 located on the inner surface of the rim. A nut 33 is tightened on to the portion of the screw 32 which protrudes radially inwards beyond the washer 34.

FIG. 10 shows a preferred link for use in joining the ends of the band together and securing the tyre to the wheel. A first link 37 and a second link 38 are both made from metal and have apertures which are located and sized such that they may be brought into alignment when fitting the tyre. A first rivet 40 extending into a band 24′ from an upper surface 25′ of the band 24′ on a first side of a curved-topped protrusion 26b′ secures the first link 37 in place. A second rivet 39 extending into the band 24′ from the upper surface 25′ on a second side of the curved-topped protrusion 26b′ secures the second link 38 in place

Alternatively, the two ends of the band may be joined together and the tyre secured to the wheel by any suitable means. For instance, an adhesive or glue may be used. However, mechanical fixing means such as a screw and nut may be preferred, since it may then be possible to repeatedly fit and remove the tyre from the wheel. For instance, a user may want to remove the tyre and replace it with a regular tyre, before then deciding to revert after a period of time to the tyre according to the invention.

The tyre may be provided already attached, either permanently or releasably, to a wheel.

The band may be made from a material other than Nylon®, e.g. rubber or another polymeric material.

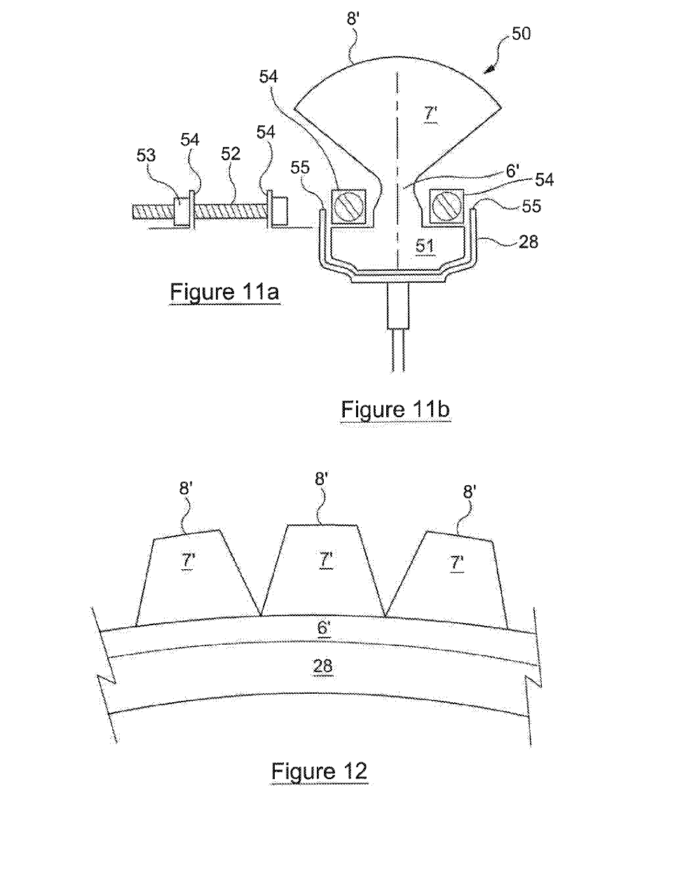

Referring to FIG. 11a, FIG. 11b and FIG. 12, part of a tyre 50 according to a fourth embodiment of the invention is shown, comprising a base 51, a neck portion 6′ and a plurality of head portions 7′. Each head portion 7′ has a curved top 8′, which provides, in use, a ground-contacting surface. The head portions 7′ are each connected to the base 51 by the neck portion 6′, which is resilient, and is configured to flex so as to allow each head portion 7 to tilt laterally. In this embodiment, each head portion 7′ is generally sector shaped in cross-section and has a tapering profile from the side (viewed in a direction parallel to the axis of rotation of the wheel or tyre). The head portions 7′ each meet at their base, and the neck portion 6′ is thereby substantially continuous along the circumference of the tyre 50. The neck portion 6′ extends from the base 51, the base 51 being configured to sit within the rim 28 of a wheel. The base 51 is provided with receiving formations 54 that extend out from the base 51 in a substantially radial direction. Each receiving formation 54 has an aperture therethrough, for receiving, in use, a fastening means.

The tyre 50 is in the form of an elongate strip which is fitted by wrapping it around the rim 28 of a wheel. Each end of the elongate strip is provided with a pair of receiving formations 54, one either side of the neck portion 6′. The tyre 50 is configured to be fitted at least partly within the rim 28, so that the pairs of receiving formations 54 face each other, with the tyre extending substantially around the entire circumference of the wheel. Suitable fastening means may subsequently be used to fix the receiving formations 54 adjacent to one other. Preferably, the fastening means may be suitable for imparting a tension in the tyre 50, to assist in retaining it on the wheel. Conveniently, the fastening means may comprise at least one nut 53 and a bolt 52. The receiving formations 54 conveniently may comprise radially extending brackets, e.g. metal or plastic brackets, with corresponding through holes that are adjacent when the tyre 50 is assembled, the through holes being configured to accept fastening means.

The tyre 50 may comprise a rubber material, and, optionally, may be reinforced with a second material. The second material may comprise nylon or metal fibres, or may comprise a nylon or metal mesh. The reinforcing material may be configured to improve the compressive stiffness of the head portions 7. The reinforcing material may be incorporated by moulding into the tyre 50. The tyre 50 may be extruded. The tyre 50 may be preferably formed of a single integral part.

The range of lateral tilt of each head portion 7′ is limited, in this embodiment, by the rim 28, which contacts the side face of a head portion 7′ when the head portion 7′ has reached a pre-determined angle of tilt. Each head portion 7′ is pivotable about an axis parallel to the circumference of the wheel or tyre, defined by the neck portion 6′.

Referring to FIG. 13, part of a fifth embodiment of a tyre 80 according to the invention is shown, comprising a plurality of separable tyre elements 70 arranged around a wheel to form a tyre. Each tyre element 70 comprises two substantially flat faces 70a, 70b opposite to one another, which are substantially parallel and extend, in use, radially outwards from the wheel. Each tyre element 70 is conveniently of constant shape in cross section between the two flat faces. It will be appreciated that these features may enable the tyre element 70 to be readily produced by extrusion. Conveniently, each tyre element 70 may comprise a rubber material.

As is more clearly shown in FIG. 15a and FIG. 15b, each tyre element 70 comprises a head portion 7″, a neck portion 6″ and a base portion 51′. As can be seen from FIG. 15a and FIG. 15b, the head portion 7″ has a curved top 8″, which provides, in use, a ground-contacting surface. The head portion 7″ is generally sector-shaped in cross-section. The base portion 51′ is configured to be at least partially received within a rim 28″ of a wheel, and comprises a first hump 4a′ and a second hump 4b′ located either side of the neck portion 6″. The neck portion 6″ is resiliently deformable so that the head portion 7″ can tilt laterally. The range of lateral tilt of the head portion 7″ is limited by contact with the first and second humps 4a′, 4b′. The first and second humps 4a′, 4b′ project laterally from the base portion 51′, so that, in use, they overlie the radially projecting edges of the rim 28″. Conveniently, the lower surface of each hump 4a′, 4b′ engages with the rim 28″, in use, so that each hump 4a′, 4b′ is supported by the rim 28″. Alternatively or additionally, the bottom of the base portion 51′ may be adapted to engage with the bottom of the trough of the rim 28″.

The base portion 51′ further comprises a through hole 83, which is arranged so that, when the tyre element is engaged with the rim 28″, the through hole 83 is substantially tangential to the circumference of the wheel or tyre.

Referring again to FIG. 13, the tyre elements 70 are arranged, in use, in a substantially regular array around the circumference of the wheel or tyre, each adjacent pair of tyre elements being separated by a spacer 82.

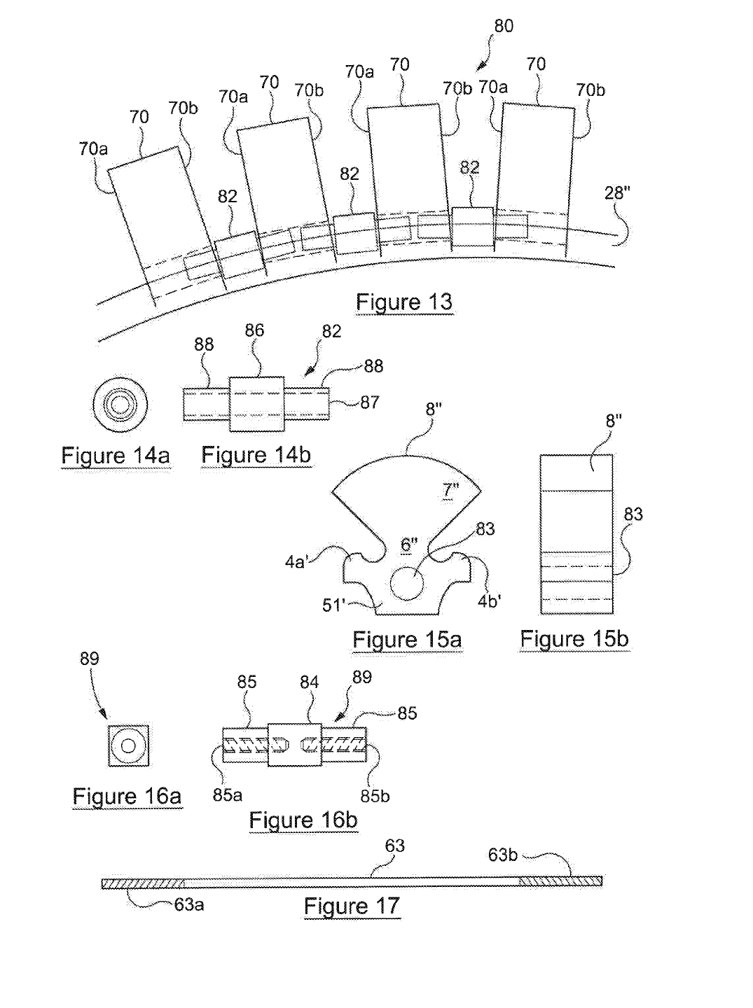

The spacer 82 is more clearly shown in FIG. 14a and FIG. 14b, and is of substantially cylindrical form, with two end regions 88 having a smaller radius than a central region 86. A through hole 87 is provided co-incident with the axis of the spacer 82. As is clear from FIG. 13, the substantially cylindrical exterior surface of each end region 88 is configured to be received within the through hole 83 of the tyre element 70 of this embodiment. The transition between the central region 86 and end regions 88 of the spacer 82 defines a flat stop surface at either side of the central region 86, for engagement with a flat face 70a, 70b of each tyre element 70. The spacer 82 conveniently may comprise a plastics material.

In order to secure the array of tyre elements 70, separated by spacers 82, to the wheel, a flexible, elongate member 63 is provided that can be threaded through the through hole 87 of each spacer 82 and the through hole 83 in each tyre element 70. The ends of the elongate member 63 may subsequently be secured together to form a continuous circular tyre wrapped around a wheel rim. The elongate member 63 may comprise a wire and/or may be jointed along its length. Preferably, the elongate member 63 may be formed from a strong material such as metal, e.g. steel. Conveniently, the elongate member 63 may comprise a wire hoop having a circular cross section, with threaded portions 63a, 63b at each end, as shown in FIG. 17. The elongate member 63 may have a diameter of between 3 mm and 5 mm, e.g. 4 mm Preferably, the threaded portion 63a, 63b at one end comprises a left hand thread, and the threaded portion 63a, 63b at the other end comprises a right hand thread. The ends of the elongate member 63 may be secured together using a nut 89, as shown in FIG. 16a and FIG. 16b.

The nut 89 is similar in form to the spacer, in that it comprises a central region 84 and two end regions 85. The two end regions 85 have substantially cylindrical external surfaces that are configured to be received within the through hole 83 of the tyre element 70 in the same way as those of the spacer 82. The central region 84 of the nut 89 has a non-circular cross section, by which the nut 89 may be rotated to engage the nut 89 onto a thread. Conveniently, the central region 84 may have a non-circular, e.g. polygonal such as square, cross section. In contrast to the spacer 82, which has a through hole 87 sized to provide a clearance fit with the elongate member, the nut 89 is provided with a threaded hole 85a, 85b at either end, corresponding with the threaded end portions 63a, 63b of the elongate member 63. In the example embodiment, there are two blind threaded holes 85a, 85b, but it will be appreciated that a through hole may also be used. The nut 89 preferably may comprise a metal material, for example steel or aluminium.

To assemble the tyre 80, the appropriate length of elongate member 63 (corresponding with the circumference of the wheel) is first selected, and an array of alternate tyre elements 70 and spacers 82 disposed thereon, the array of tyre elements 70 and spacers 82 having a tyre element 70 at either end. The partly assembled tyre is then wrapped around the wheel, with the base of each tyre element 70 being received within the rim 28″. The ends 63a, 63b of the elongate member 63 are thereby brought into adjacency, and the nut 89 may be used to both secure the ends 63a, 63b together, and to impart tension to the elongate member 63. Such tension will tend to further secure the tyre elements 70 in the rim 28″. A degree of flexing of the spacers 82 and tyre elements 70 may be necessary to accommodate the circular shape of the tyre.

Referring to FIG. 18 part of a sixth embodiment of a tyre 60 is shown, The tyre 60 comprises a plurality of rollers 61, each supported by an individual housing 62. Each roller 61 is similar in form to the roller 15a of FIG. 3. As shown in FIG. 20a and FIG. 20b, each roller 61 has a curved top 61a, which provides, in use, a ground-contacting surface. Each roller 61 is generally sector-shaped in cross-section. Each roller 61 has a through hole 73 for receiving a cylindrical bearing 72. In this embodiment, each housing 62 supports a roller 61 in a clevis type arrangement, with a substantially cylindrical bearing 72 extending from a first clevis plate of the housing 62, through the full width of the roller 61 to a second clevis plate of the housing 62. The housing 62 has a base portion 69, which is configured to be at least partially received within the rim of a wheel. The outward faces of the clevis plates of the housing 62 may be configured to taper outwards radially from the wheel in use, such that adjacent faces of neighbouring housings 62 are substantially parallel when the tyre 60 is assembled on a wheel.

In this embodiment, each bearing 72 is tubular, having an axial through hole, and a plurality of housings 62 with rollers 61 are arranged adjacent to one another on an elongate member, wrapped around a wheel in a similar way to the fifth embodiment. The elongate member 63′ in this embodiment is threaded through the axial through hole of each bearing 72 of the plurality of housings 62. The elongate member 63′ preferably may comprise a steel hoop. The elongate member 63′ may have a diameter of around 4 mm. The elongate member 63′ is provided with a left-hand and right-hand threaded end portion. The ends of the elongate member 63′ are secured together by a nut 64, the nut 64 having left- and right-hand threaded internal holes 66 for receiving the end portions of the elongate member 63′.

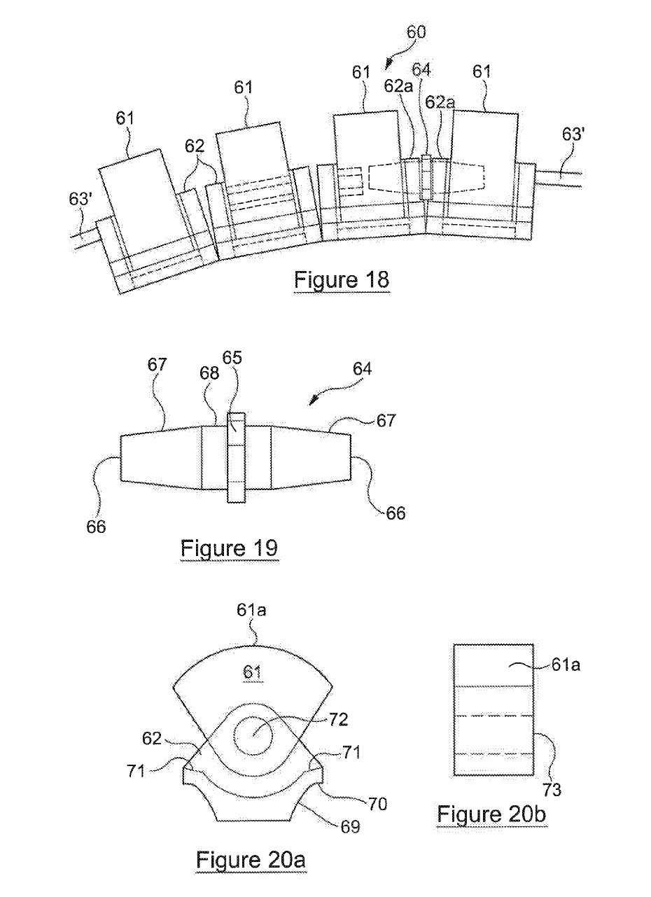

The nut 64 is more clearly shown in FIG. 19, and comprises a two end portions having a substantially frusto-conical external surface 67, tapering towards each end of the nut 64. The central region of the nut 64, between the end portions, comprises a central portion 65 with a non-circular cross section, for gripping with a spanner. To either side of the central portion 65 are portions with a substantially cylindrical external surface 68 configured to be received within the outward facing clevis plate of each end housing.

The majority of the tyre is formed from a series of identical housings 62 and rollers 61, but the final housing at either end of the elongate member 63 has a different design, being an end housing 62a. Each end housing 62a is arranged to receive part of the central region of the nut 64, and further comprises a recess to accommodate the central portion 65 when the two end housings are brought in contact with one another.

The housing 62, 62a may comprise a plastics material, for example nylon, and the roller 61 may comprise a rubber material. The nut 64 may comprise a metal material, or a plastics material with a metal threaded insert.

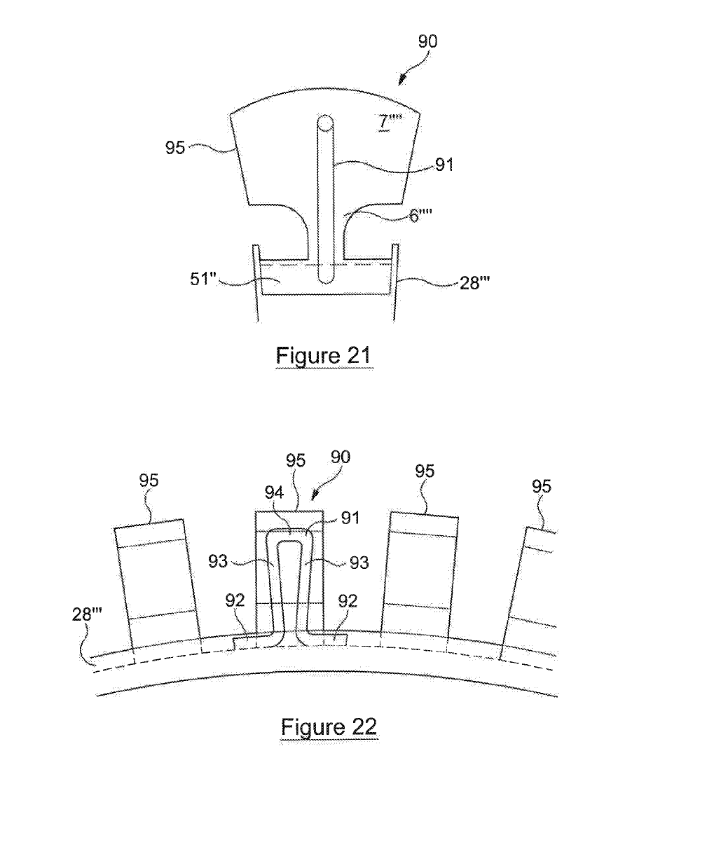

A seventh embodiment is shown in FIGS. 21 and 22. This embodiment is similar to that of FIGS. 11 and 12, in that a tyre 90 includes a continuous base portion 51″, which is configured to be received within the rim 28′″ of a wheel. A plurality of tyre elements 95 depend outwards from the base 51″, each tyre element 95 comprising a neck portion 6″″ and a head portion 7″″. A gap is provided between each tyre element 95. The head portion 7″″ is attached to the base portion 51″ by the neck portion 6″″, which is resiliently deformable so as to allow the head portion 7″″ to tilt laterally of the wheel, in use. The range of tilt of the head portion 7″″ is limited by the rim 28′″, which will come into contact with the head portion 7″″ when the head portion 7″″ has reached a predetermined angle of tilt.

In this seventh embodiment, the tyre 90 comprises a reinforcing member 91 which runs continuously through the tyre. The reinforcing member 91 extends through the base portion 51″, up into the head portion 7″″ and from there back down into the base portion 51″. As is shown in FIG. 22, the reinforcing member 91 comprises a plurality of substantially straight portions, joined by bends, including inner circumferential portions 92, that extend between the tyre elements, outward portions 93 that extend outward into the head portion 7″″ of each tyre element 95, outer circumferential portions 94, that extend circumferentially within the head portion 7″″ of each tyre element 95, and a further inward portion 94 that rejoins a further inner circumferential portion 92.

The reinforcing member 91 may conveniently comprise a wire, e.g. a metal (for instance steel) wire. The reinforcing member 91 may have a diameter of between 1 mm and 5 mm, e.g. 4 mm.

The reinforcing member 91 runs continuously around the full length of the tyre 90, and provides additional stiffness and strength to the tyre 90.

It will be appreciated that the features of each embodiment may be adapted for use with other embodiments. For example, instead of being separated by a spacer, each tyre element of FIG. 13 may instead be supported by a housing, similar to that of the sixth embodiment.

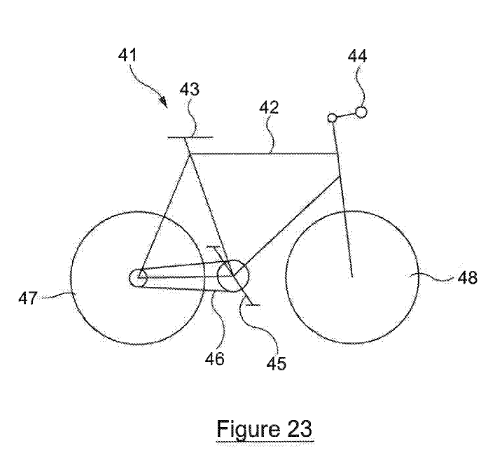

FIG. 23 shows a bicycle 41 in accordance with the invention. The bicycle 41 comprises a frame 42, a seat or saddle 43, handlebars 44, pedals 45, a front wheel 48, a rear wheel 47 and a chain 46 operably connecting the pedals 45 to a hub of the rear wheel 47. The rear wheel 47 is fitted with one of the wheels or tyres described above and illustrated in any of FIGS. 1 to 22, thereby allowing a rider of the bicycle 41 to perform or simulate a drift, slide, broadside or skid. Advantageously, the drift, slide, broadside or skid can be performed or simulated in a controllable and relatively safe manner on standard road surfaces such as tarmac or asphalt as well as loosely packed “off-road” surfaces.

Including the inventor, three generations of the inventor's family have tested the invention in private. The tests were carried out on tarmac. As well as demonstrating that the invention works, the testers had a lot of fun and it may be noted that they managed to perform the maneuvers, e.g. drifting, sliding, figures-of-eight etc., safely and without falling off or crashing.

It is envisaged that the invention may be applied to almost any kind of bicycle, e.g. mountain bikes, BMX bikes, cruiser bikes, hybrid bikes, commuter bikes, tandem bikes, touring bikes and road bikes. The invention may be applied to any size of bicycle from bikes designed for children to bikes designed for adults. The invention may be applied to bicycles having battery-driven electric motors.

The front wheel and/or the rear wheel of a bicycle may be fitted with a wheel or tyre according to the invention.

The invention may be applied to other pedal-driven, bicycle-like vehicles such as unicycles, tricycles and quadracycles. For instance, one or more of the rear wheels of a tricycle may be provided with a wheel or tyre according to the invention.

Tyres according to the invention may have the form of tubular-type tyres as well as clincher-type tyres.

Advantageously, the invention may allow a cyclist to increase his confidence and bike-handling skills, whilst also being fun. Thus, by using the invention, a cyclist may become a more competent and/or a safer cyclist. This may be of benefit to everyday and recreational cyclists as well as keen or professional cyclists who may race on- and/or off-road.

The invention may, therefore, have a use as a training aid as well as providing cyclists with a means of having fun on a bike.

It is envisaged that the invention could be used in a racing format that might be similar to motorcycle speedway, since competitor cyclists would be able to drift, slide, broadside or skid when cornering. This contrasts with traditional bicycle speedway, in which the competitors barely slide or skid as they corner.

Competitors in such a racing format may be well placed to move on to competing in motorcycle speedway. Thus, the invention may provide a safe, relatively cheap way, e.g. for children and less-experienced riders, speedway-type racing and/or a training aid for motorcycle speedway riders.

It is also envisaged that wheels or tyres of the invention may be used on motorised vehicles such as motorcycles, mopeds, scooters, quad-bikes and the like.

It is further envisaged that wheels or tyres of the invention may be used on other vehicles, e.g. industrial vehicles. In particular, vehicles operating in pipes, tubes, troughs, channels or at the base of slopes may benefit from being fitted with one or more wheels or tyres according to the invention, since the wheels or tyres may help the vehicle to maintain a course at the bottom of a pipe, tube, trough or slope in or on which the vehicle is operating. Hence, the vehicle may be provided with an in-built resistance to climbing an inner wall of a pipe or tube or an inner wall or a side wall of a channel or trough. The wheels or tyres according to the invention may cause the vehicle to drift in such a manner that the vehicle may tend to correct its course if it starts to climb an inner wall of a pipe or tube or an inner wall or a side wall of a channel or trough. Vehicles operating in pipes, e.g. pipelines or sewers, often may be remote controlled and may not carry any personnel. Typically, such a vehicle may comprise a tool. Examples of such vehicles may include pipeline pigs and remote controlled drilling and/or cutting tools for removing blockages from pipelines, e.g. oil and gas or other industrial pipelines. Remote control of a vehicle within a pipe or tube may be easier if the vehicle is provided with one or more wheels or tyres according to the invention.

Various modifications of the exemplary embodiments disclosed herein will occur to the person skilled in the art without departing from the scope of the present invention.

What is claimed is:

1. A wheel or tyre for a bicycle comprising a ground-contacting surface, at least a portion of the ground-contacting surface being carried on a movable portion having a degree of freedom about an axis parallel to a circumference of the wheel or tyre.

2. The wheel or tyre according to claim 1, wherein the wheel or tyre is configured such that the movable portion can move, in use, by no more than a predetermined amount.

3. The wheel or tyre according to claim 2, wherein the predetermined amount is measured relative to a plane of rotation of the wheel or the tyre, in use.

4. The wheel or tyre according to claim 1, wherein the movable portion may be freely rotatable about the axis parallel to the circumference of the wheel or tyre.

5. The wheel or tyre according to claim 2, wherein the predetermined amount is no more than 90° or no more than 70° or no more than 60° in each direction from a central point.

6. The wheel or tyre according to claim 1, wherein the ground-contacting surface is curved.

7. The wheel or tyre according to claim 1, wherein the movable portion comprises a roller segment.

8. The wheel or tyre according to claim 2, wherein the wheel or tyre comprises at least one stop means arranged to prevent the movable portion moving beyond the or a predetermined amount.

9. The wheel or tyre according to claim 1, wherein the wheel or tyre comprises at least one resilient element connecting the or each movable portion to a fixed point on the wheel or the tyre.

10. The wheel or tyre according to claim 9, wherein the movable portion is resiliently tiltable or rotatable.

11. The wheel or tyre according to claim 10, wherein the movable portion comprises a stud, a fin or a rib.

12. The wheel or tyre according to claim 1, further comprising: at least one resilient element connecting the or each movable portion to a fixed point on the wheel or the tyre and at least one stop means; wherein the resilient element(s) and the stop means are arranged such that, in use, the movable portion is resiliently tiltable or rotatable by no more than the or a predetermined amount relative to the or a plane of rotation of the wheel or the tyre.

13. The wheel or tyre according to claim 1, comprising a plurality of movable portions spaced around the circumference of the wheel or tyre.

14. The wheel or tyre according to claim 1, wherein the ground-contacting surface comprises a tread.

15. The wheel or tyre according to claim 1, further comprising a locking means which may be engagable to prevent or at least minimise movement of the movable portion.

16. The wheel or tyre according to claim 1, wherein the wheel or tyre is provided as a kit of component parts that may be assembled and configured by the user.

17. The wheel or tyre according to claim 1, comprising a plurality of separable tyre elements or rollers, which, when assembled, comprise at least part of a tyre.

18. The wheel or tyre according to claim 17, further comprising a plurality of separate spacers, separating each adjacent pair of tyre elements.

19. The wheel or tyre according to claim 17, comprising a plurality of rollers, further comprising a plurality of separate roller housings, each roller housing supporting a roller bearing.

20. The wheel or tyre according to claim 17, comprising a plurality of tyre elements, wherein each tyre element comprises:
a base portion configured to be at least partially received within a wheel rim;
a head portion comprising a ground contacting surface; and
a resiliently deformable neck portion joining the head portion to the base portion.

21. The wheel or tyre according to claim 17, further comprising an elongate, flexible member for securing the plurality of tyre elements or rollers to the wheel rim, each tyre element or roller having a through hole for accepting the elongate member.

22. The wheel or tyre according to claim 21, wherein the elongate member comprises a threaded portion at an end thereof.

23. The wheel or tyre according to claim 22, wherein the elongate member comprises a threaded portion at a first and second end thereof, and the threaded portion at the first end is left hand threaded, and the threaded portion at the second end is right hand threaded.

24. The wheel or tyre according to claim 23, further comprising a nut, the nut comprising a first and second threaded portion, the first and second threaded portions of the nut respectively corresponding to the threaded portion at the first and second end of the elongate member.

25. The wheel or tyre according to claim 8, wherein the stop means comprises a wheel rim.

26. The wheel or tyre according to claim 1, wherein the moveable portions are fixed to a base, the base being configured to be received within a wheel rim, and having a first and second end, wherein the first and second end of the base are adapted to be secured together by removable fastening means.

27. The wheel or tyre according to claim 26, wherein the removable fastening means is operable to tension the wheel around the wheel rim.

28. A bicycle comprising at least one wheel or tyre according to claim 1.

29. A method of manufacture or assembly of a bicycle comprising:
providing a wheel according to claim 1 and a bicycle frame; and
fitting the wheel to the bicycle frame.

30. A method of manufacture or assembly of a bicycle comprising:
providing a tyre according to claim 1, a bicycle frame and a bicycle wheel for fitting to the bicycle frame;
fitting the tyre to the wheel; and
subsequently fitting the wheel to the bicycle frame.

31. A method of modifying a bicycle comprising replacing a wheel or tyre of the bicycle with a wheel or tyre according to claim 1.
